(19) United States
(12) Patent Application Publication
(10) Pub. No.: US 2006/0089862 A1
(43) Pub. Date: Apr. 27, 2006

(54) System and method for modeling benefits

(76) Inventors: Sudhir Anandarao, Vienna, VA (US); Lawrence N. Croney, Springfield, VA (US); Rahul Ghate, Fairfax, VA (US); Anand Iyengar, Centerville, VA (US); Sreedhar V. Potarazu, Potomac, MD (US); James T. Tierney, Potomac Falls, VA (US)

Correspondence Address: COOLEY GODWARD LLP;ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/972,300

(22) Filed: Oct. 25, 2004

(51) Int. Cl. G06Q 40/00

(52) U.S. Cl. 705/4

(57) ABSTRACT

Data of one or more individuals associated with a benefit plan are analyzed. The data can include information about benefits provided to the one or more individuals under the benefit plan, such as a medical benefit plan, a prescription benefit plan, or a retirement benefit plan. One or more expenses of the benefit plan are modeled at least partially based on the analyzed data. The modeling includes determining a change in the one or more expenses based on modification of a parameter of the benefit plan.

### FIELD OF THE INVENTION

The invention generally relates to healthcare-related benefits and other benefits. More specifically, the invention relates to modeling of benefits, including but not limited to medical benefits, prescription benefits, and retirement benefits.

### BACKGROUND

Various important benefits can be, and have been traditionally, provided to individuals by way of benefit plans. For example, benefits such as medical benefits, prescription benefits, and retirement benefits are frequently provided to individuals, as beneficiaries, for example, by way of benefit plans offered by a provider, such as an employer, for example. Benefit plans also can be administered by a third party, which may be neither a provider nor a beneficiary to the benefit plan.

Administration of benefit plans can be complex. For example, the benefit plans themselves can be rather complex and take into consideration numerous factors, some of which may not be readily appreciated from a casual review or understanding of the benefit plan. Additionally, implementation of even a simple benefit plan can be complex, and require consideration of numerous factors. Nevertheless, benefit plans can be important to many individuals who are beneficiaries under or otherwise participate in the plans.

In recent years, costs associated with some benefit plans have increased, causing concern to both plan providers and plan beneficiaries or members. For example, a major component of some benefit plans is medical costs or other healthcare-related costs. As medical and healthcare-related costs have increased in recent years, so too have costs associated with the various plans. These increased costs are often, in turn, passed through to the plan provider and/or the plan membership. In addition to concern over rising medical or healthcare-related costs, concern sometimes exists for the efficiency of a benefit plan, or other factors that can cause benefit-plan-related expenses to rise.

Based on concern for efficiency and/or rising costs associated with various benefit plans, analysis and management tools and techniques of those benefit plans have increased in importance and demand in recent years. Current benefit plan analysis and management tools and techniques, however, are rather limited in the functionality that they provide. For example, standard analysis and management tools and techniques make use of standardized and/or estimated information that may not be associated with the plan membership (e.g., plan beneficiaries). Thus, analysis of a particular benefit plan performed using existing techniques that are based on standardized or estimated information not associated with individuals within the plan membership may or may not be applicable to that particular benefit plan. Additionally, because of the complex nature of functions performed by such analysis and management tools, receiving results of such analysis and management tools may take longer than desired by a plan sponsor or administrator. For example, such analysis and management tools often require actuarial assistance, which can delay results of any analysis significantly.

Accordingly, it would be desirable to develop a system and method for modeling benefits that overcomes problems and shortcomings associated with prior approaches.

### SUMMARY

One or more embodiments of the invention provide a system and method for modeling benefits that overcome problems associated with prior approaches and provide other novel aspects. For example, healthcare-related benefits, such as medical benefits, prescription benefits, or other similar benefits can be modeled according to one or more embodiments of the invention. Additionally, or alternatively, other benefits, such as retirement benefits, can be modeled according to one or more embodiments of the invention.

According to one or more embodiments of the invention, a method and a processor-readable medium is provided, and includes analyzing data of at least one individual from multiple individuals associated with a benefit plan. The data analyzed includes information about benefits provided to the at least one individual under the benefit plan. The method also includes modeling at least one expense from multiple expenses of the benefit plan at least partially based on the analyzed data. The modeling also includes determining a change in at least one expense from the multiple expenses based on modification of a parameter of the benefit plan.

According to one or more other embodiments of the invention, a system is provided, and includes a data repository and a processor. The data repository is configured to store information associated with multiple individuals. The processor is in communication with the data repository, and is configured to associate information associated with at least one individual from the multiple individuals with at least one parameter of a benefit plan associated with the at least one individual. The processor is also configured to determine how a modification of the at least one parameter would change at least one expense from multiple expenses associated with the benefit plan.

According to one or more other embodiments of the invention, a method and a processor-readable medium is provided, and includes receiving a query associated with at least one parameter of a benefit plan. The query requests information about a change of expenses associated with the benefit plan based on a modification of the at least one parameter. The method also includes determining, substantially in real time, the information requested by the query using information associated with multiple individuals associated with the benefit plan.

Other advantages and features associated with embodiments of the invention will become more readily apparent to those skilled in the art from the following detailed description. As will be realized, the invention is capable of other and different embodiments, and its several details are capable of modification in various aspects, all without departing from the invention. Accordingly, the drawings and the description are to be regarded as illustrative in nature, and not limiting.

### BRIEF DESCRIPTION OF THE DRAWINGS

FIG. 1 is a block diagram showing an example of a network system including a processor system and other devices connected to a network, according to an embodiment of the invention.

FIG. 2 is a block diagram showing an example of a benefits modeling system, according to an embodiment of the invention.

FIG. 3 is a block diagram showing an example of a network-based benefits modeling system, according to an embodiment of the invention.

FIG. 4 is a flow diagram showing an example of operations performed according to an embodiment of the invention.

FIG. 5 is a block diagram showing an example of a data model, according to an embodiment of the invention.

### DETAILED DESCRIPTION

One or more systems and methods for modeling benefits are described. More specifically, an embodiment of the invention is described in the context of a system and method that analyzes and models a medical benefit plan, a prescription benefit plan, and/or a retirement benefit plan. The principles of the invention are, however, applicable to any type of benefit plan for which analysis and/or management similar to the analysis and/or management described below is desired.

As used herein, the term “benefit plan” means a system by which benefits are provided to one or more individuals that are members of the plan. For example, a benefit plan can include a medical plan, a pharmacy plan, a retirement plan, an insurance plan, a pension plan, a workers compensation plan, a disability plan, a dental-care plan (also referred to as a dental plan), a vision-related plan (also referred to as a vision plan), a medical leave plan, a maternity/paternity plan, and/or other similar plans or plans that provide similar types of benefits. Additionally, a benefit plan can include a combination of two or more of the foregoing examples of benefit plans. A benefit plan can be administered, sponsored, or provided by an employer, an insurance company, a non-profit organization, or other entities having an interest in providing the associated benefits of the benefit plan. Administration, sponsorship and/or provision of a benefit plan can occur by the same entity or different entities, as desired.

As used herein, the term “member” means any individual eligible to receive benefits from a benefit plan. Generally, to be eligible to receive benefits from a benefit plan, a member must be enrolled within (or “under”) that benefit plan, according to the rules of the benefit plan. Members can also be referred to as “beneficiaries,” inasmuch as they receive benefits from the benefit plan. Members can also be referred to using designations associated with their specific benefit plan; for example, the term “retiree” can be used to describe a member of a retirement plan. A “member population” or “membership” is a group of members eligible to receive benefits from a common benefit plan.

According to one or more embodiments of the invention, benefits modeling, or modeling of various parameters of a benefit plan, are explained below with reference to a medical benefit plan, a pharmacy benefit plan, and a retiree benefit plan. The analysis, modeling and/or management provided according to one or more embodiments of the invention can be provided in real-time. Thus, a plan provider or sponsor, or other interested parties, can analyze effects of varying parameters of a benefit plan on other parameters within the benefit plan, and determine the effects in real-time.

Additionally, analysis and/or management functionality provided by way of one or more embodiments of the invention uses actual data of members of the benefit plan for which the analysis and/or management functionalities are being performed. Thus, because actual data, corresponding to actual members of the benefit plan, are used, the results of the analysis and/or management can be considered more reliable, applicable, and accurate for the specific benefit plan being analyzed and/or managed according to one or more embodiments of the invention.

Moreover, because of the real-time capabilities of one or more embodiments of the invention, interested individuals can perform numerous analyses of benefit plan data to determine almost immediately the effects of individually varying numerous parameters within that benefit plan. For example, a plan sponsor, such as an employer, can vary parameters, such as insurance premium amounts paid by the employer and/or an employee, and almost immediately determine the effect of such changes on the overall benefit plan. For example, an employer can almost immediately determine the change in a cost of the benefit plan to an employer based on changes in premium amounts. Additionally, a variety of less direct effects can be analyzed by varying other parameters. For example, an employer, or other plan sponsor, can vary prescription co-payment amounts, or medical co-payment amounts paid by an employee that is a member of the benefit plan, and almost immediately determine the effect of such changes on the overall cost of the benefit plan, or effects on a specific cost of the benefit plan, (e.g., insurance premiums, etc.).

By accurately modeling one or more benefit plans, interested individuals, such as plan sponsors or plan administrators can vary any modeled parameter and determine the effect of such variations on the overall plan, including costs to the plan sponsor, plan administrator, or plan members, for example. Thus, by determining the effect of such variations, an interested individual (e.g., a plan administrator, a plan sponsor, plan member, etc.) can undertake a “what if” analysis to determine the impact of various changes to the benefit plan. Accordingly, by performing real-time, “what if” analyses, an interested individual, such as a plan administrator, plan sponsor (e.g., an employer) or plan member can quickly determine the effect of one or more changes of parameters within a benefit plan on the overall plan, or on specific items of interest to that individual.

Additionally, an interested individual (e.g., a plan administrator, a plan sponsor, a plan member) can use one or more embodiments of the invention to tailor benefits of a benefit plan based on one or more services. For example, a benefit plan can be tailored to determine effects of adding, changing, or removing services or benefits, such as mental health services, maternity benefits, rehabilitation services (e.g., physical therapy, etc.), and so forth. Because actual data associated with members of the benefit plan are used to model, analyze, and/or manage a benefit plan, information such as the age and genders of the members, and other information associated with the members can produce more accurate results than when using standardized or estimated data. This can be particularly useful when determining effects on a benefit plan of adding, changing, or removing services or benefits that are highly dependent on characteristics of the members of the benefit plan, such as maternity benefits, for example.

Additionally, because of the real-time capabilities of one or more embodiments of the invention, analysis and/or management of benefit plans can be accomplished rapidly, and can be carried out in a network-computing environment, for example. One specific example of a network implementation includes a Web interface whereby an employer or other interested individual (e.g., plan administrator, plan sponsor, plan member, etc.) can access the functionality provided by the analysis and management tools of one or more embodiments of the invention.

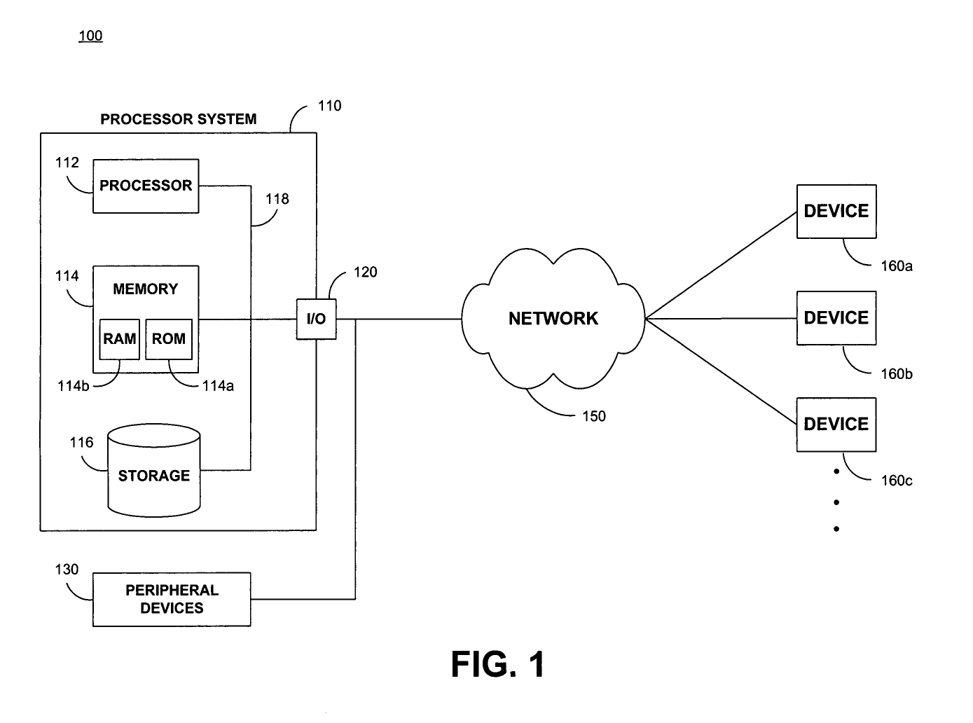

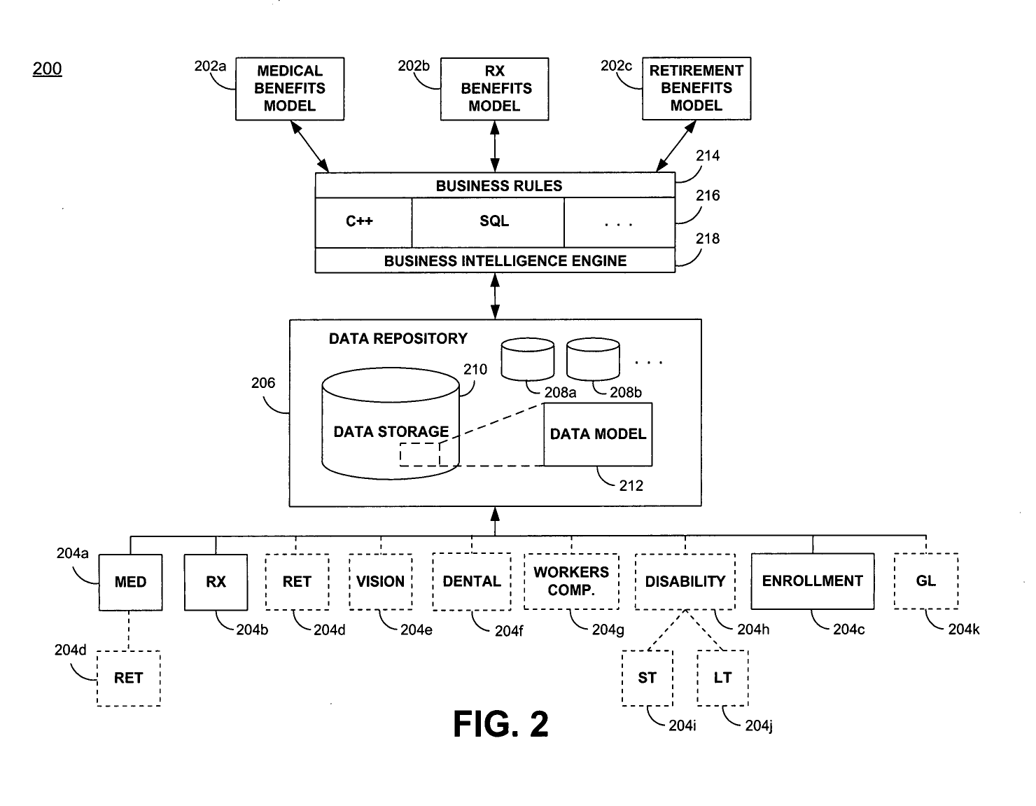

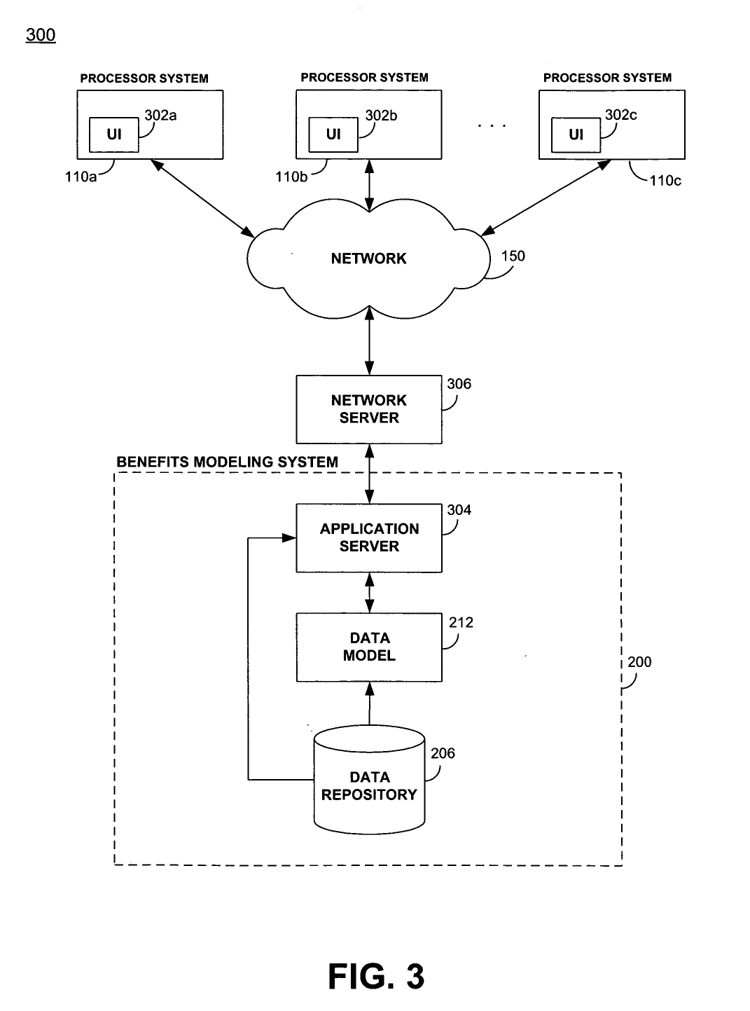

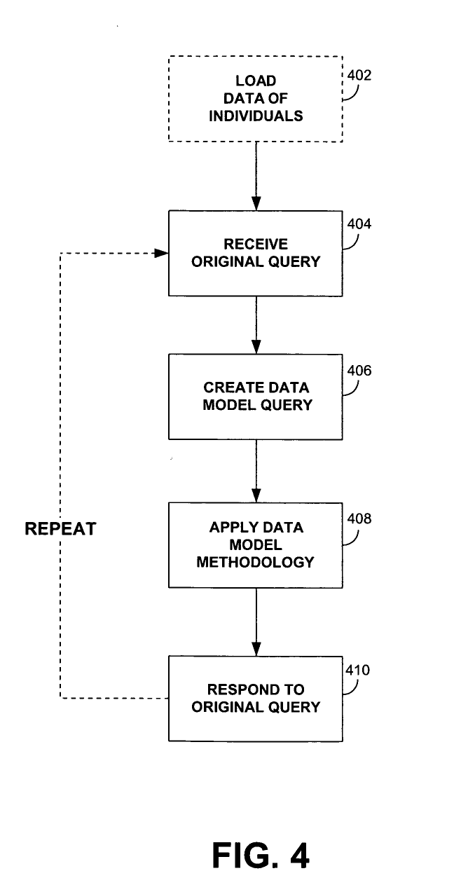

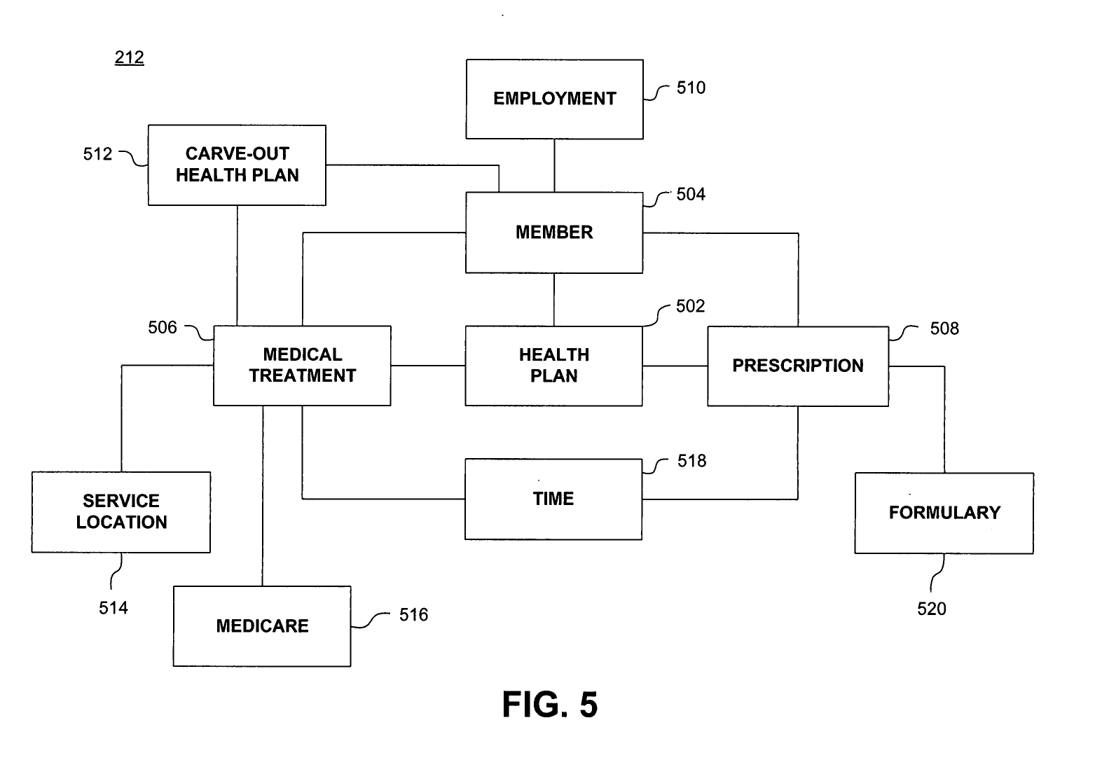

Various embodiments are described in different figures, several of which are interrelated, and then with respect to three examples. First, the figures are described, where a general network system 100 within which one or more embodiments of the invention can be implemented as shown in FIG. 1. For example, benefits modeling and analysis capabilities described herein can be performed using a device such as the processor system 110. Additionally, remotely located devices, such as the other devices 160 shown in FIG. 1 can access the modeling and analysis capabilities described herein via the network 150 in real-time, according to one or more embodiments of the invention. The system 200 shown in FIG. 2 can be implemented on a device such as the processor system 110 of FIG. 1. Additionally, as shown in FIG. 3, the system 200 of FIG. 2 can be accessed either locally or remotely via a network, such as the network 150. The system 200, when accessed remotely, can be accessed by a user interface (UI) 302 on a processor device 110 or other device 160. The technique by which either the system 200 shown in FIG. 2 or the system 300 shown in FIG. 3 is used is described in detail with reference to the operations of FIG. 4. The data model 212 used by the system 200 of FIG. 2 is shown in greater detail in FIG. 5.

After the description of the basic components, devices, methodologies, and operations of one or more embodiments of the invention is given with respect to the various figures, three examples are provided to aid illustration of one or more aspects of the invention: a medical benefits example, a prescription benefits example, and a retirement benefits example. In these examples, specific description of possible ways in which the system and method of the invention can be used with certain benefit plans is provided.

FIG. 1 is a block diagram showing an example of a network system 100 including processor system 110 and other devices 160a, 160b, 160c (referred to herein collectively, individually, or as a subset as device(s) 160) connected to a network 150, according to an embodiment of the invention. The various elements in FIG. 1 are shown in a network-computing environment 100, wherein a processor system 110 is interconnected with a network 150, by which the processor system 110 and/or multiple other devices 160 can communicate. It will be appreciated that the elements shown in FIG. 1 are examples of components that can be included in such a processor system 110 and/or devices that can be in communication with a processor system 110, and that elements can be removed or additional elements can be added depending upon the desired functionality of such a system. For example, the processor system 110 can function independently of a network 150, or can include more or fewer components than illustrated in FIG. 1.

The processor system 110 illustrated in FIG. 1 can be, for example, a commercially available personal computer (PC), a workstation, a network appliance, a portable electronic device, or a less-complex computing or processing device (e.g., a device that is dedicated to performing one or more specific tasks or other processor-based), or any other device capable of communicating via a network 150. Although each component of the processor system 110 is shown as a single component in FIG. 1, the processor system 110 can include multiple numbers of any component shown in FIG. 1. Additionally, multiple components of the processor system 110 can be combined as a single component, where desired.

The processor system 110 includes a processor 112, which can be a commercially available microprocessor capable of performing general processing operations. For example, the processor 112 can be selected from the 8086 family of central processing units (CPUs) available from Intel Corp. of Santa Clara, Calif., or other similar processors. Alternatively, the processor 112 can be an application-specific integrated circuit (ASIC), or a combination of ASICs, designed to achieve one or more specific functions, or enable one or more specific devices or applications. In yet another alternative, the processor 112 can be an analog or digital circuit, or a combination of multiple circuits.

The processor 112 can optionally include one or more individual sub-processors or coprocessors. For example, the processor 112 can include a graphics coprocessor that is capable of rendering graphics, a math coprocessor that is capable of efficiently performing mathematical calculations, a controller that is capable of controlling one or more devices, a sensor interface that is capable of receiving sensory input from one or more sensing devices, and so forth.

Additionally, the processor system 110 can include a controller (not shown), which can optionally form part of the processor 112, or be external thereto. Such a controller can, for example, be configured to control one or more devices associated with the processor system 110. For example, a controller can be used to control one or more devices integral to the processor system 110, such as input or output devices, sensors, or other devices. Additionally, or alternatively, a controller can be configured to control one or more devices external to the processor system 110, which can be accessed via an input/output (I/O) component 120 of the processor system 110, such as peripheral devices 130, devices accessed via a network 150, or the like.

The processor system 110 can also include a memory component 114. As shown in FIG. 1, the memory component 114 can include one or more types of memory. For example, the memory component 114 can include a read-only memory (ROM) component 114a and a random-access memory (RAM) component 114b. The memory component 114 can also include other types of memory not illustrated in FIG. 1 that are suitable for storing data in a form retrievable by the processor 112, and are capable of storing data written by the processor 112. For example, erasable programmable read only memory (EPROM), electrically erasable programmable read only memory (EEPROM), flash memory, as well as other suitable forms of memory can be included as part of the memory component 114. The processor 112 is in communication with the memory component 114, and can store data in the memory component 114 or retrieve data previously stored in the memory component 114.

The processor system 110 can also include a storage component 116, which can be one or more of a variety of different types of storage devices. For example, the storage component 116 can be a device similar to the memory component 114 (e.g., EPROM, EEPROM, flash memory, etc.). Additionally, or alternatively, the storage component 116 can be a magnetic storage device (such as a disk drive or a hard-disk drive), a compact-disc (CD) drive, a database component, or the like. In other words, the storage component 116 can be any type of storage device suitable for storing data in a format accessible to the processor system 110.

The various components of the processor system 110 can communicate with one another via a bus 118, which is capable of carrying instructions from the processor 112 to other components, and which is capable of carrying data between the various components of the processor system 110. Data retrieved from or written to the memory component 114 and/or the storage component 116 can also be communicated via the bus 118.

The processor system 110 and its components can communicate with devices external to the processor system 110 by way of an input/output (I/O) component 120 (accessed via the bus 118). According one or more embodiments of the invention, the I/O component 120 can communicate using a variety of suitable communication interfaces and protocols. The I/O component 120 can also include, for example, wireless connections, such as infrared ports, optical ports, Bluetooth wireless ports, wireless LAN ports, or the like. Additionally, the I/O component 120 can include, wired connections, such as standard serial ports, parallel ports, universal serial bus (USB) ports, S-video ports, large area network (LAN) ports, small computer system interface (SCSI) ports, and so forth.

By way of the I/O component 120 the processor system 110 can communicate with devices external to the processor system 110, such as peripheral devices 130 that are local to the processor system 110, or with devices that are remote to the processor system 110 (e.g., via the network 150). The I/O component 120 can be configured to communicate using one or more communications protocols used for communicating with devices, such as the peripheral devices 130. The peripheral devices 130 in communication with the processor system 110 can include any of a number of peripheral devices 130 desirable to be accessed by or used in conjunction with the processor system 110. For example, the peripheral devices 130 with which the processor system 110 can communicate via the I/O component 120, can include a communications component, a processor, a memory component, a printer, a scanner, a storage component (e.g., an external disk drive, disk array, etc.), or any other device desirable to be connected to the processor system 110.

The processor system 110 can communicate with a network 150, such as the Internet or other networks, by way of a gateway (not shown), a point of presence (POP) (not shown), or other suitable means. Other devices 160 can also access the network 150, and can be similar to or different from the processor system 110. Additionally, the other devices 160 can communicate with the network 150 (and devices connected thereto) using a network service provider (NSP), which can be an Internet service provider (ISP), an application service provider (ASP), an email server or host, a bulletin board system (BBS) provider or host, a point of presence (POP), a gateway, a proxy server, or other suitable connection point to the network 150 for the devices 160.

According to one or more embodiments of the invention, capabilities of a system or method for modeling benefits can be implemented using a processor system 110 and/or a device 160 accessible via a network 150 by the processor system 110. For example, the functionality provided by one or more embodiments of the invention can be included entirely within the processor system 110, and accessed locally on that device. Additionally, or alternatively, one or more devices 160 can access such functionality, available on the processor system 110, via a network 150, according to one or more network-based embodiments of the invention.

FIG. 2 is a block diagram showing an example of a benefits modeling system 200, according to an embodiment of the invention. The benefits modeling system 200 accesses, makes use of, and updates one or more benefits models, or models of one or more benefit plans. For example, the benefits modeling system 200 can interact with a medical benefits model 202a, a prescription benefits model 202b, and/or a retirement benefits model 202c, as well as any other models of benefit plans desirable to be used in connection with the benefits modeling system 200 of FIG. 2. The one or more benefits models 202a, 202b, 202c used in connection with the benefits modeling system 200 of FIG. 2 can be referred to collectively, individually, or as a subset, as a benefits model(s) 202.

The benefits models 202 can be based on one or more types of raw data collected by the system 200. For example, data such as medical data 204a, prescription (RX) data 204b and enrollment data 204c can be used to form or update the benefits models 202, and can be used by a benefits model 202 to determine effects of various changes of parameters of the benefit plan associated with the benefits model 202. Other types of data can also be used to form or update the benefits models 202, such as retirement data 204d, which can optionally form part of the medical data 204a or can be individual retirement data 204d, received independently of any medical data 204a.

Other types of data can optionally be used by the benefits modeling system 200, such as vision data 204e, dental data 204f, workers compensation data 204g, disability data 204h, which can include short-term (ST) disability data 204i and/or long-term (LT) disability data 204j, and other data, such as general ledger (GL) data 204k. Each of the various types of data can be referred to herein collectively, individually or as a subset as data 204. The various types of data 204 can be formatted in any manner suitable for use by the benefits modeling system 200. For example, according to one or more embodiments of the invention, the data 204 can be stored in flat files, such as comma-delimited files, or the like. Additionally, or alternatively, the various types of data 204 can be in formats accessible by commonly used applications, such as Microsoft (MS) Access database file formats and MS Excel spreadsheet formats available from Microsoft Corp. of Redmond, Wash., or other suitable formats. Additionally, one or more types of data 204, such as medical data 204a, can be in proprietary formats of one or more benefit providers (e.g., healthcare providers, Medicare providers, disability benefit providers, etc.), or other interested individuals using the benefits modeling system 200, such as a benefit plan administrator, benefit plan sponsor (e.g., employers), or the like.

The various types of data 204 can be received from one or more of a variety of sources. For example, medical data 204a can be received directly from a healthcare provider or other medical provider. Similarly, prescription (RX) data 204b can be received from a pharmacy, or other organization filling prescriptions. Additionally, or alternatively, information, such as medical data 204a, prescription data 204b, enrollment data 204c, or other types of data 204 can be received from a benefit plan sponsor, such as an employer, or the like. For example, workers compensation data 204g can be received directly from an employer, or other entity supplying a workers compensation benefit. Similarly, disability information 204h (including short-term disability 204i and long-term disability 204j) can be supplied by an entity providing disability benefits, such as an employer, or the like.

The various types of data 204 can be provided to a data repository 206 of the benefits modeling system 200. The data repository 206 can include one or more databases 208a, 208b, 210 or other data-storage mechanisms. One of the databases 210 can be used as data storage for the various types of data 204 supplied to the data repository 206. The data repository 206, or any of the databases within the data repository 208, 210 can use one or more suitable database platforms, such as platforms available from Oracle Corp. of Redwood Shores, Calif., DB/2 available from International Business Machines (IBM) of White Plains, N.Y., Sequel Server available from Microsoft, platforms available from Sybase, Inc. of Dublin, Calif., and so forth.

The data storage device 210 can, for example, standardize the various types of data 204 provided to the data repository 206. Additionally, the data storage device 210 can manipulate the provided data 204 in a variety of ways, according to the desired functionality of the benefits modeling system 200. For example, the data storage device 210 can perform various data-cleansing or data-scrubbing operations, which can be configured to cleanse the data 204 of any extraneous information prior to storing it in a manner and format useable by the benefits modeling system 200 and its components. The data storage device 210 can, thus, prepare data 204 received by the data repository for inclusion in a data model 212.

The data model 212 can optionally form part of the data storage device 210 within the data repository 206. Alternatively, the data model 212 can be independent from but in communication with the data storage device 210. For example, the data model 212 can optionally be stored in a distributed fashion over a number of databases 208a, 208b, 210 either local to or remote from the data repository 206.

The data model 212 is configured to store parameters used by the benefits modeling system 200 in a manner that is accessible to the system 200, and which can be used to form one or more benefits models 202. When one or more parameters within the data model 212 is manipulated, the benefits modeling system 200 can determine changes in the overall data model 212 or to any parameters of the data model 212 that occur by varying the data model or parameters of the data model 212. Additionally, the data model 212 can include information useful for determining benefits or changes in benefits of one or more benefits models 202. For example, the data model 212 can include information about any of the various types of received data 204, as well as various groupings or methodologies associated with the received data.

For example, data model 212, according to one or more embodiments of the invention, can make use of member condition groups (MCGs) which are described in co-pending application Ser. No. 10/863,819, filed on Jun. 9, 2004, which is incorporated by reference herein in its entirety. Additionally, other information, such as financial performance information, productivity information, and benchmark information, can also be included in the data model 212.

Information within the data repository 206, and specifically information contained within the data model 212 can be queried according to business rules 214 of the benefits modeling system 200. The business rules 214 can provide an interface by which one or more benefits models 202 can provide information to or receive information from the data repository 206 and/or the data model 212. For example, the business rules 214 can be configured such that they drive queries 216 of the data model 212 in one or more computer languages, such as C++, SQL, or other languages.

Queries 216 of the data model 212 can be structured according to the business rules 214, for example, to request the minimum amount of data required for a particular transaction, analysis, and so forth, from the data model 212. The queries 216 can be further optimized, for example by using a business intelligence engine (BIE). The business intelligence engine 218 can optimize the queries 216 provided according to the business rules 214 by issuing commands based on the queries 216 in one or more suitable languages. For example, according to one or more embodiments of the invention, the business intelligence engine 218 can create a query of the data model 212 using COM, XML, or other languages.

Additionally, or alternatively, the benefits modeling system 200 can be used with various business intelligence engines 218 that are commercially available. For example, according to one or more embodiments of the invention, the business intelligence engine 218 can be used with Microstrategy 7i software available from Microstrategy Corporation of Wilmington, Del. Other suitable, commercially available business intelligence components can serve as the business intelligence engine 218 of the benefits modeling system 200, if desired. For example, the business intelligence engine (BIE) 218 can operate using one or more business intelligence platforms, including platforms available from Microstrategy, Business Objects available from Business Objects, SA of San Jose, Calif., Cognos Performance Management available from Cognos, Inc. of Ottawa, Canada, Microsoft Analysis Services, or a proprietary BIE platform. Additional detail regarding the business rules 214, the queries 216, and the business intelligence engine 218 are provided below.

The business rules 214, the queries 216 and the business intelligence engine 218 together apply a modeling methodology, allowing the various benefit plans employed by the benefits modeling system 200 of FIG. 2 to have specific benefits models 202 based on information in the data model 212, which is in turn based on data 204 received by the data repository 206.

FIG. 3 is a block diagram showing an example of a network-based benefits modeling system 300, according to an embodiment of the invention. The network-based benefits modeling system 300 of FIG. 3 is described in connection with its use, which is shown in the flow diagram illustrated in FIG. 4, which shows an example of operations performed according to an embodiment of the invention. Thus, components of the network-based benefits modeling system 300 are described in connection with an example of their specific operations illustrated in FIG. 4.

The benefits modeling system 300 shown in FIG. 3 is a network-based modeling system 300 that can be used according to one or more embodiments of the invention, and can take advantage of the real-time capabilities of various embodiments of the invention. In the network-based modeling system 300 of FIG. 3, multiple processor systems 110a, 110b, 110c can be coupled to or otherwise in communication with one or more networks 150. (Alternatively, other devices 160 capable of communication via the network 150 can be used in the network-based modeling system 300 in place of the processor systems 110.) By way of the network 150, the various processor systems 110 can communicate with one another, or with other devices (e.g., devices 160 shown in FIG. 1) in communication with the network 150. The functionality available to the processor systems 110 can be accessed via a user interface (UI) 302a, 302b, 302c, which can be, for example, a graphical interface (GUI), or other suitable interface.

According to one or more embodiments of the invention, the user interface 302a can use an operating system (OS) as a UI 302 to access functionality of the modeling system 300 or the processor-system 110 on which it resides. Various types of suitable operating systems can be used as the UI 302; for example, operating systems implementing the UI 302 on each processor system 110 can be any operating system suitable for allowing a user to interface with the processor system 110 and/or network functionality via the network 150. Such an operating system can be a Microsoft Windows-based operating system (e.g., Windows 2000, Windows XP, etc.), a Unix-based or Unix-related operating system (e.g., Unix, Linux, AIX, HP-UX, etc.), a Solaris operating system available from Sun, or other suitable operating system.

The user interface (UI) 302 can access the network 150 and various capabilities provided via the network 150 using, for example, a web browser, such as Microsoft Internet Explorer, a Mozilla-based web browser (e.g., Mozilla, Mozilla Firefox, etc.), Netscape available from Netscape Communications Corp. of Mountain View, Calif., Opera available from Opera Software of Oslo, Norway, or any other suitable web browser.

The network-based modeling system 300 can also include the components of the benefits modeling system 200 described above in connection with Figure two such as the data repository 206 and the data model 212 and an application server 304 configured to perform functions of the benefits modeling system 200, as well as a network server 306. The application server 304 can provide a variety of functionality, such as the functionality afforded by business rules 214 (shown in FIG. 2), queries 216 formed according to those business rules 214, and/or a business intelligence engine (BIE) 218, all of which can provide access to the functionality afforded by the data model 212.

The network server 306 can either form part of the benefits modeling system 200 of FIG. 2, or can be separate from that system 200 and configured to provide access to the network 150 by one or more devices of the benefits modeling system 200, such as the application server 304, for example. The network server 306 can be any server suitable for providing network communications functionality. For example, the network server 306 can be a Web server, such as an Apache Web server or a Tomcat Web server available from the Apache Software Foundation of Forest Hill, Md., a IIS Web Server available from Microsoft Corp. of Redmond, Wash., or a WebSphere server available from IBM.

The network-based system 300 of FIG. 3 uses data, such as the received data 204 (shown in FIG. 2), which is associated with individuals, such as individuals within a benefit plan. Referring to FIG. 4, the data used by the network-based system 300 can be optionally loaded into the data repository in operation 402. This information can be pre-loaded, prior to use of the network-based benefits modeling system 300 of FIG. 3 from one or more entities, such as a benefit provider, or other suitable entity. This can be accomplished, for example, according to a predetermined schedule, or at any other convenient time.

After data has been loaded into the data repository 206, it can be provided to the data model 212 for later access by the network-based benefits modeling system 300. By way of a user interface 302, a user can access the network 150 and provide or receive information via the network to the benefits modeling system 200. For example, a user can, via the UI 302, provide a request for analysis of a benefit plan or some aspect of such a plan, or change a parameter associated with a benefit model of one or more benefit plans. For example, a user can change a parameter and determine the effect of that change on the overall benefit plan, to accomplish a “what if” analysis.

The network server 306 receives the analysis and/or change request by the user, which it passes to the application server 304, which receives the request in operation 404. The application server 304 then creates a data model query in operation 406 based on business rules 214. The business intelligence engine 218 can further optimize the query. As discussed above, the application server 304 can optimize the data model query 216 created in operation 406 in one or more of a couple of ways: first, the application server 304 can apply the business rules 214 (e.g., to request the minimum amount of data required for the query received from the user); and second, the application server 304 can optimize the request 216 formed using the business rules 214 using a business intelligence engine (BIE) 218.

Based on the data model query created in operation 406, which is received from the application server 304, raw data associated with that query, or raw data required to analyze the effects of the query are provided by the data repository 206 to the application server 304. The application server 304 then communicates with the data model 212, and applies the methodology of the data model 214 in operation 408 to the received raw data. By applying the methodology of the data model 214, the application server 304 can determine the desired analysis of the original query received in operation 404, or the effect of a change in parameters requested by the original query received in operation 404.

The methodology of the data model 212 can be applied in operation 408 by the application server 304 using a tailored application, configured to apply the data model 212 methodology, in an efficient manner. For example, according to one or more embodiments of the invention, the application server 304 can apply the methodology of the data model 212 using a custom C++ application, or an application in another suitable, low-level language for such a task. According to one or more embodiments of the invention, it may be desirable to create some applications configured to apply the methodology of the data model 212 in a low-level language, because low-level languages can, in some circumstances, provide shorter computation times and may allow for results to be known sooner.

Once the methodology of the data model 212 has been applied by the application server 304 in operation 408, a response to the user's original query (i.e., the query received in operation 404) is formulated and provided in operation 410. This response can be provided from the application server 304 to the user, via the network server 306, the network 150, and the user interface 302 associated with the user that provided the original query in operation 404.

Because of the nature of the benefits modeling system 200 and the network-based benefits modeling system 300, a response to a query can be provided in operation 410 to a user via the network 150 substantially in real time. For example, according to one or more embodiments of the invention, a response to a query (received either locally or via a network) can be provided in less than one minute. The response time can vary, however, according to the complexity of the data model 212, the complexity of the query, or based on other system or design constraints, or other parameters. After each response to a query in operation 410, the technique shown in FIG. 4 can repeat, and another “original” or user query can be received in operation 404, for which the analysis of operations 406, 408, and 410 is performed.

The data model methodology can be applied in a variety of ways in operation 408 depending upon the various types of benefit plans involved and the parameters of those benefit plans. Three examples of how the data model methodology can be applied in operation 408 are described below with reference to specific examples of a medical benefits model 202a (shown in FIG. 2), a prescription benefits model 202b, and a retirement benefits model 202c, respectively. The examples presented below are simply examples of how the various data model methodologies can be applied, and other techniques besides those described below can be used according to one or more embodiments of the invention.

Medical Benefits Example

For a medical benefits model 202a, medical data of a predetermined period, such as the prior four fiscal quarters, or any number of contiguous quarters, can be monitored. Options (i.e., benefit plan options that are offered by a vendor) that have 8000 or more life years (e.g., number of covered lives for the selected rolling four quarters of medical claims data) can be assigned a credibility factor C of 1.0, which represents a reliability of claims data. Options with fewer than 8000 life years can be modeled, and assigned a credibility factor that is calculated as shown below in Equation 1:

$$C = \frac{MIN ( 8000 , {Y}_{med} )}{8000} , \qquad ( 1 )$$

where C is the credibility factor, MIN is a minimum factor that selects the minimum value from a set of values (e.g., between 8000 and the variable Y_{med}), and Y_{med} is the number of covered life years of medical claims data (e.g., of a plan sponsor or administrator, etc.). According to Equation 1, for example, if the number of covered life years of medical claims data Y_{med} available is only 4000, then the credibility factor C would be 0.5 (e.g., the data may be only considered only half as reliable as when the number of covered life years of medical claims data is 8000, or whatever number is determined to be necessary to achieve a reliable credibility).

For some benefit plan characteristics to be accurately modeled, a minimum amount of time that those plan characteristics have been in place may be required according to one or more embodiments of the invention. For example, if a predetermined time period (e.g., the prior four quarters) is selected for modeling options that include per-visit co-payment amounts and/or plan-year deductibles, those options may only be accurately modeled if those features were implemented prior to the predetermined time period (e.g., the prior four quarters). Even if those features must be implemented prior to the predetermined period (e.g., the prior four quarters) for accurate modeling, the deductible cycle does not have to be in synch with the selected predetermined period (e.g., the prior four quarters).

An induction factor of medical expenditures can be determined and can vary with the mix and size of the types of claims. The induction factor represents a change in beneficiary behavior towards the demand for health services as a result of increase/decrease in co-pay, co-insurance or deductible amounts. For example, an induction factor If is used to calculate a cost A associated with a change in demand for health care as shown in Equation 2 below:
A=(P₂−P₁)·(I_{f}), (2)
where P₁ is a first payment amount (e.g., a co-pay, co-insurance, or deductible payment amount) and P₂ is a second payment amount. Thus, according to Equation 2, if a co-payment amount is increased from $10 to $30, and the induction factor I_{f} is 50%, the cost associated with the change in demand for health care as a result of the increase in the co-payment amount would be $10.

The induction factor can be entered by the end-user (e.g., a benefit plan sponsor, a benefit plan administrator, etc.). Alternatively, a default value can be used. For example, a default value can be a weighted average induction factor of fifty percent for all types of medical expenses. Various percentage weights can be assigned to inpatient hospital expenses (e.g., thirty percent) and outpatient expenses (e.g., seventy percent).

According to one or more embodiments of the invention, a predetermined period (e.g., the prior four quarters) for which medical data is analyzed can exclude the most recent data (e.g., data from the most recent quarter) to account for medical claim lag or other delays. Exclusion of recent data can be a choice implemented by a user (e.g., via the UI 302 of FIG. 3), or can, alternatively, be implemented automatically by a benefits modeling system (e.g., the benefits modeling system 200 or the network-based benefits modeling system 300).

Various input parameters and other values can be used in connection with the medical benefits model 202a. For example, inputs can include an option or information associated therewith. Another input parameter can include a selection or indication of whether, in applying the data model methodology in operation 408 (shown in FIG. 4), an entire option is to be modeled, or if only a specific program or service (e.g., maternity benefits, mental health services, rehabilitation services, etc.) is to be modeled. Another input parameter can include what predetermined period is to be modeled. For example, a user can enter (via the UI 302 of FIG. 3) the prior quarters to be modeled (e.g., a number of consecutive quarters, the prior four quarters, the three consecutive quarters immediately preceding the prior quarter, etc.).

Data of a medical benefits model 202a used according to one or more embodiments of the invention can include, for example, various types of co-payment information, co-insurance information, and deductible information, as well as other factors such as an expected enrollment change (i.e., the percent increase or decrease in enrollment under a benefit plan or an option expected over the next year), a medical inflation trend (i.e., the percent of increase or decrease in inflation expected for medical expenditures over the next year), and an induction factor (i.e., the change in beneficiary behavior towards the demand for health services as a result of increase/decrease in co-pay, co-insurance or deductible amounts). The various types of co-payment information, for example, can include inpatient and outpatient co-pay amounts, in-network and out-of-network co-pay amounts, office visit amounts, emergency room visits, laboratory amounts, X-ray amounts, and so forth. Likewise, any types of co-payment information, co-insurance information, and deductible information desired to be modeled can be included in the model.

Some examples of input parameters and associated values that can be used in connection with the medical benefits model 202a are shown in Table 1 below. These values are merely a limited number of examples, however, and a variety of other values can be used, depending upon the desired functionality of the benefits modeling system 200.

TABLE 1
Examples of input parameters and associated
values of the medical benefits model

| | |
|---|---|
| Input Parameters | Associated Values |

Co-Payment Amounts

| | |
|---|---|
| Co-pay - Inpatient, | 0 to 200, in 10 dollar |
| In network | increments |
| Co-pay - Inpatient, | 0 to 200, in 10 dollar |
| Out of network | increments |
| Co-pay - Outpatient, | 0 to 200, in 10 dollar |
| In network | increments |
| Co-pay - Outpatient, | 0 to 200, in 10 dollar |
| Out of network | increments |
| . . . | . . . |

Co-Insurance Amounts

| | |
|---|---|
| Coinsurance - Inpatient, | 50 to 100, in 5 percent |
| In Network | increments |
| Coinsurance - Inpatient, | 50 to 100, in 5 percent |
| Out of Network | increments |
| Coinsurance - Outpatient, | 50 to 100, in 5 percent |
| In Network | increments |
| Coinsurance - Outpatient, | 50 to 100, in 5 percent |
| Out of Network | increments |
| . . . | . . . |

Deductible Amounts

| | |
|---|---|
| Individual Deductible | 0 to 2000, in 50 dollar |
| | increments |
| Individual Deductible, | 0 to 2000, in 50 dollar |
| In Network | increments |
| Individual Deductible, | 0 to 2000, in 50 dollar |
| Out of Network | increments |
| . . . | . . . |

Other Factors

| | |
|---|---|
| Individual Out-of-Pocket | 0 to 5000, in 100 dollar |
| Maximum | increments |
| Expected Enrollment Change | 0 to 50, 0 to −50, in |
| | 5 percent increments |
| Medical Inflation Trend | 0 to 50, in 1 percent |
| | increments |
| Induction Factor | 0 to 250, in 5 percent |
| | increments |
| | Default value: 50% |

Medical benefits modeling can apply the parameters described above (as well as other parameters desired to be monitored) to each beneficiary of a medical benefit plan. Additionally, new beneficiaries, and amounts paid by those new beneficiaries, as well as amounts paid by others (e.g., an employer) on behalf of the beneficiaries can be tracked and modeled similarly. The medical benefits model 202a can take other factors of a medical benefit plan into account as well. For example, the medical benefits model 202a can ensure that the beneficiary only pays the total amount, if the total amount is less than the co-pay or the deductible (e.g., for a co-insurance plan).

Amounts paid by one or more members (or beneficiaries) and amounts paid by a plan sponsor (e.g., an employer) can be aggregated to identify the total amounts paid by all beneficiaries and all amounts paid by a plan sponsor. Induction can then be applied to account for changes in behavior and the historical trend can be applied to identify prospective amounts paid by a plan sponsor (e.g., an employer) and a member (e.g., a beneficiary) for the selected, predetermined period (e.g., a rolling four quarters). This data can be segmented and presented in a variety of ways, depending upon the desires of users of the system (e.g., a plan administrator, a plan sponsor, a plan member, etc.). Thus, different payment amounts, totals, and sub-totals can be calculated for any group of members or other interested individuals associated with the medical benefit plan.

If a user of the benefits modeling system 200 (shown in FIG. 2), for example, selects a specific program or service (e.g., maternity benefits, newborn care, mental health services, substance abuse services, rehabilitation services, etc.) the model is executed on only those medical claims that beneficiaries made pertaining to that specific program or service. According to one or more embodiments of the invention, for example, plan inputs used for such programs or services as maternity benefits, newborn care, mental health services, substance abuse services, and rehabilitation services, can be the same as the ones that apply to the entire option. Any inputs for the option that do not apply to a particular program or service can optionally be set to zero when running the model. For example, if rehabilitation services only have certain co-pay amounts (e.g., for outpatient, in-network and outpatient, out of network) the other input parameters can be set to zero.

According to one or more embodiments of the invention, certain carve-outs can be employed using the business rules 214 (shown in FIG. 2), examples of which are illustrated in Table 2 below.

TABLE 2
Examples of carve-outs

| Program/Service | Selection Criteria |
|---|---|
| Maternity, | Claims where the primary Expanded |
| newborn care | Diagnosis Cluster (EDC) = Pregnancy and |
| | delivery, uncomplicated; Pregnancy and |
| | delivery with complications; Complications |
| | of pregnancy and childbirth; Prematurity |
| Mental Health and | Claims where the primary Expanded |
| Substance Abuse | Diagnosis Cluster (EDC) = Anxiety, |
| | neuroses; Attention Deficit Disorder; |
| | Behavior problems; Depression; Family |
| | and social problems; Personality disorders; |
| | Schizophrenia and affective psychosis; |
| | Substance abuse; Tobacco abuse |
| Rehabilitation | Claims where the primary CPT codes = |
| | {predetermined CPT codes} |

Using data of the medical benefits model 202a, the amounts paid by a benefit plan member (e.g., an employee) and a benefit plan sponsor (e.g., an employer) can be calculated based on different predetermined periods (e.g., the previous four quarters, a rolling four-quarter period, etc.), and different types of medical benefit plans (e.g., deductible-based plans, co-pay plans, co-insurance plans, etc.), options, programs and/or services. Additionally, trend amounts can be calculating using the medical inflation trend amount, for example, or any other trend amounts available.

Once the desired calculations of amounts paid by a member of a benefit plan and/or a sponsor of a benefit plan have been performed, a determination of an allocation of deductible and out-of-pocket-maximum amounts can be made, if the option has an overall plan deductible and out of pocket maximum. Various determinations regarding the deductible and/or out-of-pocket-maximum amounts can be made based on the type of medical care or service rendered to a member. The allocation of the deductible and/or the out-of-pocket-maximum amounts can be different depending upon the particular benefit plan or insurance plan to which the medical benefits model 202a is being applied. For example, if an option has separate amounts for in-network versus out-of-network care, such differences must be taken into account in calculating the correct deductible and/or out-of-pocket-maximum amounts.

According to one or more embodiments of the invention, the calculation of various medical amounts paid by benefit plan members (e.g., employees) is performed prior to performing other operations on those amounts, such as induction, or the like. Similarly, if a member uses a specific program or service, but also has a general deductible that would apply in addition to any program or service amounts, that amount can be calculated prior to any program or service amounts.

The total amounts paid by a member of a medical benefit plan both before and after induction, and the total amounts paid by a plan sponsor of a medical benefit plan both before and after induction can be determined across all members. Adjustments for co-pay factors can be made to these amounts, and changes in the calculations of amounts paid before induction can be determined, as well.

It should be recognized that the effect of induction on medical expenditures can vary according to the mix, size, and types of claims. The induction effect for inpatient hospital expenses, for example, can be 30 percent, and the induction effect for outpatient expenses, for example, can be 70 percent. Users of the benefits modeling system 200 can enter an “expected medical claims induction factor” as part of the input parameters, which can have a default value that is a weighted average induction factor of 50 percent.

The input interface (e.g., the UI 302 of FIG. 3) for the medical benefits model 202a can be a browser window that allows input and/or manipulation of the parameters associated with that model. The input interface can include, for example, a notes section, which can optionally be collapsible, containing assumptions of the medical benefits model 202a and any constraints associated therewith. Also, the notes section can include a description of the credibility factor described above. Another section that can be presented via the input interface (e.g., after the input parameters section) can contain help information (e.g., in the form of a glossary). The input interface can include a variety of graphical components to aid a user in inputting and/or modifying various parameters, such as pull-down menus, graphical buttons, check boxes, and so forth. It should be noted that the input interface can also serve as an output interface, in as much as it displays output from the medical benefits model 202a (e.g., in response to input provided to the input interface).

According to one or more embodiments of the invention, the medical benefits model 202a can produce multiple outputs for a single simulation. For example, for each time the data model methodology is applied in operation 408 (shown in FIG. 4), three analyses can be run for three different Induction factors: 25%, 50% and 75%. The output from the operation can be displayed, for example, as low-induction, medium-induction and high-induction results.

Output from the medical benefits model 202a can include, for example, sponsor-paid medical costs (across all members of the medical benefit plan) and member-paid medical costs (across all members of the medical benefit plan) for a predetermined or selected period (e.g., four consecutive quarters), which can be displayed as a yearly amount. Additionally, or alternatively, a proposed plan after induction for the sponsor (across all benefit plan members), and a proposed plan after induction (across all benefit plan members) for a predetermined or selected period (e.g., four quarters), which can be displayed as a yearly amount. The output of the medical benefits model 202a can also include the credibility factor, and output can be presented as a grid or graph, which can highlight distribution of and changes in costs.

Prescription Benefits Example

For a prescription benefits model 202b, prescription data of a predetermined period, such as the prior four fiscal quarters, or any number of contiguous quarters, can be monitored. Options (i.e., benefit plan options that are offered by a vendor) that have 3000 or more life years (e.g., number of covered lives for the selected rolling four quarters of medical claims data) can be assigned a credibility factor C of 1.0, which represents a reliability of claims data. Options with fewer than 3000 life years can be modeled, and assigned a credibility factor that is calculated according to Equation 1 above with 3000 being substituted for 8000 in that equation.

For some benefit plan characteristics to be accurately modeled, a minimum amount of time those plan characteristics have been in place may be required according to one or more embodiments of the invention. For example, if a predetermined time period (e.g., the prior four quarters) is selected for modeling options that include per-visit co-payment amounts and/or plan-year deductibles, those options may only be accurately modeled if the those features were implemented prior to the predetermined time period (e.g., the prior four quarters). Even if those features must be implemented prior to the predetermined period (e.g., the prior four quarters) for accurate modeling, the deductible cycle does not have to be in synch with the selected predetermined period (e.g., the prior four quarters).

The prescription benefits model 202b is similar in many ways to the medical benefits model 202a; however, some parts of the model are different. As with the medical benefits model 202a, an induction factor of prescription expenditures associated with the prescription benefits model 202b can be determined and can vary with the mix and size of the types of claims. The cost associated with a change in demand for health care using the induction factor can be calculated using Equation 2 above.

According to one or more embodiments of the invention, the induction factor for prescription expenditures is generally higher than the induction factors used for medical expenditures. For example, the induction factor can be assumed to be 100%, meaning that every dollar that a prescription is increased, the demand is likely to change in an amount that will cause a loss in that same amount of dollars. Additionally, given the rapidity with which prescription drug claims are often paid out, the pharmacy model assumes that there is no claim lag in the data, according to one or more embodiments. Of course the lag can be varied according to the needs of one or more individuals associated with the prescription benefits model 202b.

Various input parameters and other values can be used in connection with the prescription benefits model 202b. For example, inputs can include an insurance option or information associated therewith. Another input parameter can include what predetermined period is to be modeled. For example, a user can enter (via the UI 302 of FIG. 3) the prior quarters to be modeled (e.g., a number of consecutive quarters, the prior four quarters, the three consecutive quarters immediately preceding the prior quarter, etc.). Additionally information regarding the status of the member of the prescription benefit plan (e.g., an employment status of an employee or the employee's family, etc.) Other inputs for the prescription benefits model 202b can include various co-payment amounts (e.g., generic, brand in formulary, brand out formulary, etc.), co-insurance amounts (e.g., generic, brand in formulary, brand out formulary, etc.), a deductible amount, an out-of-pocket maximum amount, an adjustment for changes in a mandatory mail-order requirement, an expected enrollment change, a prescription-drug inflation trend, and an induction factor.

Data of a prescription benefits model 202b used according to one or more embodiments of the invention can include, for example, any of the input parameters mentioned above.

Some examples of input parameters and associated values that can be used in connection with the prescription benefits model 202b are shown in Table 3 below. These values are merely a limited number of examples, however, and a variety of other values can be used, depending upon the desired functionality of the benefits modeling system 200.

TABLE 3
Examples of input parameters and associated
values of the prescription benefits model

| Input Parameters | Associated Values |
|---|---|
| Option | Obtained from the |
| | enrollment/claims feed. |

Co-Payment Amounts

| | |
|---|---|
| Co-pay - Generic | 0 to 100, in 1 dollar |
| | increments |
| Co-pay - Brand in | 0 to 100, in 1 dollar |
| Formulary | increments |
| Co-pay - Brand Out | 0 to 100, in 1 dollar |
| of Formulary | increments |
| . . . | . . . |

Co-Insurance Amounts

| | |
|---|---|
| Co-Insurance - Generic | 50 to 100, in 5 percent |
| | increments |
| Co-Insurance - Brand in | 50 to 100, in 5 percent |
| Formulary | increments |
| Co-Insurance - Brand Out | 50 to 100, in 5 percent |
| of Formulary | increments |
| . . . | . . . |

Other Amounts

| | |
|---|---|
| Individual Deductible | 0 to 2000, in 50 dollar |
| | increments |
| Individual Out of pocket | 0 to 5000, in 100 dollar |
| maximum (including | increments |
| deductible) | |
| Adjustment for changes | No change in requirement, |
| in mandatory | Plan changes from Non- |
| Mail-order requirement | Mandatory to Mandatory, Plan |
| | changes from Mandatory to |
| | Non-mandatory |
| Expected Enrollment | 0 to 50, 0 to −50, in |
| Change | 5 percent increments |
| Prescription Drug - | 0 to 50, in 1 percent |
| Inflation Trend | increments |
| Induction factor | 0 to 250, in 5 percent |
| | increments |
| | Default value: 100% |
| . . . | . . . |

Prescription benefits modeling can apply the parameters described above (as well as other parameters desired to be monitored) to each beneficiary of a prescription benefit plan. Additionally, new beneficiaries, and amounts paid by those new beneficiaries, as well as amounts paid by others (e.g., an employer) on behalf of the beneficiaries can be tracked and modeled similarly. The prescription benefits model 202b can take other factors of a prescription benefit plan into account as well. For example, the prescription benefits model 202b can ensure that the beneficiary only pays the total amount, if the total amount is less than the co-pay or the deductible (e.g., for a co-insurance plan).

Amounts paid by one or more members (or beneficiaries) and amounts paid by a plan sponsor (e.g., an employer) can be aggregated to identify the total amounts paid by all beneficiaries and all amounts paid by a plan sponsor. Induction can then be applied to account for changes in behavior and the historical trend can be applied to identify prospective amounts paid by a plan sponsor (e.g., an employer) and a member (e.g., a beneficiary) for the selected, predetermined period (e.g., a rolling four quarters). This data can be segmented and presented in a variety of ways, depending upon the desires of users of the system (e.g., a plan administrator, a plan sponsor, a plan member, etc.). Thus, different payment amounts, totals, and sub-totals can be calculated for any group of members or other interested individuals associated with the medical benefit plan.

According to one or more embodiments of the invention, the prescription benefits model 202b and/or the results of applying the methodology of that data model (e.g., from operation 408 of FIG. 4) can be configured to support the retirement benefits model 202c and/or results of applying the methodology of the retirement benefits model 202c. For example, the prescription benefits model 202b allows segmentation according to employment status. For example, a user can run the prescription benefits model 202b using only data from retired beneficiaries or members, if desired.

As with the medical benefits model 202a above, the prescription benefits model 202b applies a methodology that allows a user to determine the total prescription costs paid by a prescription benefit plan member (e.g., an employee) and/or a sponsor (e.g., an employer) of such a plan. Totals for the member and/or the sponsor can be operated on based on different options associated with the prescription benefits plan. For example, different insurance structures can be accounted for in calculation of such costs including, for example, as three-tiered insurance structures (e.g., including co-payments and/or co-insurance, etc.). These amounts can be calculated before an induction is calculated. The total amounts for the member (e.g., employee) and/or sponsor (e.g. employer) can be calculated both before and after the induction factor is calculated or taken into account.

As with the medical benefits model 202a above, the prescription benefits model 202b can include an input interface similar to the one described above in connection with the medical benefits model 202a. The prescription benefits model 202a can output a variety of information via the input interface including, for example, both sponsor-paid (e.g., employer-paid) prescription costs (across all benefit plan members), and member-paid (e.g., employee-paid) prescription costs (across all benefit plan members) for a predetermined or selected period (e.g., four consecutive quarters), each of which can be displayed as a yearly amount. Additionally, or alternatively, the prescription benefits model 202a can output sponsor-paid prescription costs and a proposed plan after induction (across all beneficiaries), as well as member-paid prescription costs and a proposed plan after induction (across all beneficiaries) for a predetermined or selected period (e.g., four consecutive quarters), which can be displayed as a yearly amount. Additionally, or alternatively, the credibility factor can be output, as well as one or more grids or graphs illustrating cost distribution of and/or changes in costs.

Retirement Benefits Example

The design of a retirement benefits model 202c can be tailored for members who are covered by Medicare (e.g., retirees 65 years old or older) and/or by sponsored benefit plan (e.g., an employer-sponsored plan). To this end, the benefits model 202c includes integration of Medicare costs, as well as co-insurance, deductible, and out-of-pocket-maximum costs. The retirement benefits model 202c can be used with benefit plans or options that already include retirees covered by Medicare, and can accept additional retirees into the system. The retirement benefits model 202c can help provide a comprehensive medical and prescription benefit plan design for retirees if medical and prescription claims data associated with the selected option or benefit plan is available.

According to one or more embodiments of the invention, data associated with retirement benefits of a predetermined period, such as the prior four fiscal quarters, or any number of contiguous quarters, can be monitored using the retirement benefits model 202c. Options (i.e., benefit plan options that are offered by a vendor) that have 3000 or more life years (e.g., number of covered lives for the selected rolling four quarters of medical claims data) can be assigned a credibility factor C of 1.0, which represents a reliability of claims data. Options with fewer than 3000 life years can be modeled, and assigned a credibility factor that is calculated according to Equation 1 above with 3000 being substituted for 8000 in that equation.

For some benefit plan characteristics to be accurately modeled, a minimum amount of time those plan characteristics have been in place may be required according to one or more embodiments of the invention. For example, if a predetermined time period (e.g., the prior four quarters) is selected for modeling options that include per-visit co-payment amounts and/or plan-year deductibles, those options may only be accurately modeled if the those features were implemented prior to the predetermined time period (e.g., the prior four quarters). Even if those features must be implemented prior to the predetermined period (e.g., the prior four quarters) for accurate modeling, the deductible cycle does not have to be in synch with the selected predetermined period (e.g., the prior four quarters).

To account for the flow of people into a retirement benefit plan, a user of the benefits modeling system 200 can, according to one or more embodiments of the invention, manipulate an expected enrollment change value to account for changes in a population trend. For example, the expected enrollment change, which is the percent increase or decrease in enrollment expected in a particular option or benefit plan over the next year, can determine how the number of new members enrolling in a retirement benefit plan will affect the costs and services of that plan.

According to one or more embodiments of the invention, an out-of-pocket maximum of the retirement benefits model 202c does not include amounts paid in deductibles. Therefore, the potential maximum of expenses of a member of a retirement benefit plan are the sum of deductible and the out-of-pocket maximum associated with the plan.

The retirement benefits model 202c can also include the Medicare-paid amounts. Either the actual amounts can be included, or the Medicare amounts can be derived. Additionally, according to an embodiment of the invention, the retirement benefits model 202c assumes that the percentage of providers who accept and do not accept Medicare assignment remains generally stable.

The retirement benefits model can include a number of input parameters, such as information about an option, a predetermined period of time (e.g., a series of consecutive quarters), a Medicare integration method, a deductible, a co-insurance amount, and out-of-pocket amount, information about a comprehensive prescription drug benefit, an induction factor, and expected enrollment change.

Some examples of input parameters and associated values that can be used in connection with the retirement benefits model 202c are shown in Table 4 below. These values are merely a limited number of examples, however, and a variety of other values can be used, depending upon the desired functionality of the benefits modeling system 200.

TABLE 4
Examples of input parameters and associated
values of the prescription benefits model

| Input Parameters | Associated Values |
|---|---|
| Option | Medical and/or prescription options |
| | obtained from the enrollment/claims |
| | feed |
| Medicare Integration | Coordination-of-Benefits, |
| Method | Exclusion, Carve-Out |
| Deductible | 0 to 2000, in 50 dollar increments |
| Co-Insurance Inpatient | 50 to 100, in 5 percent increments |
| | Default: 100% |
| Co-Insurance Outpatient | 50 to 100, in 5 percent increments |
| | Default: 100% |
| Out-of-Pocket Maximum | 0 to 5000, in 100 dollar increments |
| Comprehensive | Yes, No |
| Prescription Drug benefit | |
| Induction Factor | 0 to 250, in 5 percent increments |
| Expected Enrollment | −50 to 50, in 5 percent increments |
| Change | |
| Health Care Inflation | 0 to 50, in 1 percent increments |
| Trend | |

Retirement benefits modeling can apply the parameters described above (as well as other parameters desired to be monitored) to each beneficiary of a retirement benefit plan. Additionally, new beneficiaries, and amounts paid by those new beneficiaries, as well as amounts paid by others (e.g., an employer) on behalf of the beneficiaries can be tracked and modeled similarly. The retirement benefits model 202c can take other factors of a retirement benefit plan into account as well. For example, prescription drug plans with separate plan design (non-comprehensive) can be modeled in the prescription benefits model 202b (and used by the retirement benefits model 202c) by choosing the prescription option, where retirees are enrolled and/or selecting a “Retiree” employment status in a prescription benefits model 202b.

When the methodology of the retirement benefits model 202c is applied in operation 408 (shown in FIG. 4), it is applied to retirement-related costs (e.g., costs associated with an option, etc.) for a predetermined or selected period (e.g., four rolling quarters), according to one or more embodiments of the invention. Additionally, a user can select a Medicare integration method, as shown above in Table 4. The retiree benefits model 202c then recalculates payments to calculate and apply a beneficiary cost sharing algorithm. The recalculated payments are then compared with the historical beneficiary cost sharing results to determine the effect of induction and to calculate the new benefit plan sponsor (e.g., employer) and member (e.g., beneficiary) costs and share of costs. These amounts can then be summarized across all beneficiaries and modified by the selected expected enrollment change and health care inflation trend.

As with the medical benefits model 202a and the prescription benefits model 202b above, the retirement benefits model 202c can include an input interface similar to the ones described above in connection with the medical benefits model 202a and the prescription benefits model 202b. The retirement benefits model 202c can output a variety of information including, for example, information similar to information output via the input interfaces associated with the medical benefits model 202a and the prescription benefits model 202b described above. Additionally, the interface can include a collapsible section with glossary information and a description of the different Medicare Integration methods.

The retirement benefits model 202c can support various types of Medicare, including a full-coordination-of-benefits (full COB) plan, an exclusion plan, and a carve-out plan. A full COB plan pays the difference between total eligible charges and the Medicare reimbursement amount, or the amount it would have paid in the absence of Medicare, if less. An exclusion plan applies its normal reimbursement formula to the amount remaining after Medicare reimbursements have been deducted from total eligible charges. A Carve-Out plan applies its normal reimbursement formula to the total eligible charges, and then subtracts the amount of Medicare reimbursement.

According to one or more embodiments of the invention, the retirement benefits model 202c can provide a variety of different outputs (e.g., via the “input interface”) described above. For example, an amount paid by a plan sponsor (across all members of a benefit plan) and an amount paid by a plan member (across all members of a benefit plan) for a predetermined or selected period (e.g., four sequential quarters), which can be displayed as a yearly amount. Additionally, or alternatively, the retirement benefits model 202c can output a proposed plan to a plan sponsor and/or a member after induction, inflation, and/or enrollment change has been performed with the selected integration method across all beneficiaries for a predetermined or selected period (e.g., four sequential quarters), which can be displayed as a yearly amount. Additionally, or alternatively, prices can be adjusted by an adjustment factor. A credibility factor or other information can also be output by the retirement benefits model 202c.

According to one or more embodiments of the invention, retirement costs can be predicted for individuals prior to retirement. To facilitate such predictions, individuals that are not retirees, but which are part of either the medical benefit plan or the prescription benefit plan, or both. By analyzing costs stored in either the medical benefits model 202a or the prescription benefits model 202b associated with members, estimated future Medicare payment amounts can be derived.

FIG. 5 is a block diagram showing an example of a data model 212, according to an embodiment of the invention. The data model 212 shown in FIG. 5 is a simplified model of a relational database configuration that can be used in the benefits modeling system 200 (shown in FIG. 2) and/or the network-based benefits modeling system 300 (shown in FIG. 3). The model 212 shown in FIG. 5 is, however, a simplified example only, and can contain additional complexities not illustrated in FIG. 5. Additionally, the specific design of the data model 212 can vary significantly from the configuration shown in FIG. 5, depending upon the desired performance of the data model 212 or a system using the data model 212.

It should be recognized that the data model 212 shown in FIG. 5 is intended to illustrate only one possible implementation, and elements not shown in the data model 212 of that figure can be added and/or elements shown in the data model 212 of that figure can be removed, depending upon the specific requirements for a benefit plan, or benefit plan model. Moreover, relationships between the various elements or entities within FIG. 5 can be added to or deleted from the simplified data model 212 illustrated in FIG. 5, and can include one-to-one, one-to-many, and/or many-to-many relationships depending upon the specific data tables used and the desired function of the data model 212 and the system accessing such data model 212.

Additionally, it should be recognized that each entity illustrated in FIG. 5 can include multiple dimensions (e.g., multiple data tables), which can be interconnected or otherwise interrelated in many different ways. Data tables within an entity of the data model 212 shown in FIG. 5 can be in the form of informational tables (e.g., tables that store discrete information about an aspect of the corresponding entity), relational tables (e.g., tables that relate information contained in multiple tables, such as look-up tables), or other convenient formats.

In the data model 212 shown in FIG. 5, multiple entities are illustrated having interconnected relationships. For example, a health plan entity 502 is shown relating to other entities, including a member entity 504, a medical treatment entity 506, and a prescription entity 508.

The health plan entity 502 can include a coverage dimension, a claim dimension, a charge-type dimension, a provider dimension, an insurance-plan dimension, and a pharmacy dimension. The coverage dimension, claim dimension, and charge-type dimension can include, for example, one or more data tables storing coverage-type information, claim information, and charge-type information, respectively. A provider dimension can include information about a provider used under a health care plan, such as specialty information and provider-type information. This information can be used, for example, to analyze the validity of diagnosis codes received from a provider, or to analyze costs for different types of providers (e.g., doctor versus dentist, specialist versus generalist, “in-plan” versus “out-of-plan,” etc.). The insurance-plan dimension can include data tables storing information regarding a vendor, such as whether the plan is a health maintenance organization (HMO) or not, what the type of the insurance plan is, any option information, if applicable, and the like. The pharmacy dimension can include information regarding specific pharmacies, such as the types of those pharmacies, or other relevant information.

The member entity 504 is shown relating to numerous other entities, including the health plan entity 502 described above, the medical treatment entity 506, the prescription entity 508, an employment entity 510, and a carve-out health plan entity 512.

The member entity 504 represents all relevant personal information of a member within a healthcare plan. For example, the member entity 504 can include multiple dimensions and/or multiple data tables (each of which is configured to be populated with relevant information necessary for any desired analysis using the data model 212). The member entity 504 can include, for example, a member dimension, which can include information relating to a member's MCGs, gender, salary, disability status, and so forth. The information of the member dimension can be stored in one or more data tables. For example, according to one or more embodiments of the invention, the member dimension can include a member-group data table configured to relate a diagnostic code with an MCG of clinically related diagnostic codes.

The member dimension of the member entity 504 can also include at least one data table configured to store, on an individual-member-basis, medical health benefits cost information and/or other healthcare-related cost information for each MCG associated with the member. The member entity 504 can also include an age dimension, which can include information relating to a member's age, and can, according to one or more embodiments of the invention, categorize a member within one or more age groups or sub-groups. Additionally, the member entity 504 can also include a relation-type dimension that specifies relationships unique to a member, such as between the member and an employer, or the like.

The medical-treatment entity 506 is shown relating to numerous other entities, including the health plan entity 502 and the member entity 504 described above, the carve-out-health-plan entity 512, a service-location entity 514, a Medicare entity 516, and a time entity 518.

The medical-treatment entity 506 can include information from a variety of dimensions, including a medical-encounter dimension, a surgical-procedure dimension, a medical-intervention dimension, and a drug dimension. The medical-encounter dimension and surgical-procedure dimension include data tables configured to store data regarding a medical encounter and a surgical procedure (e.g., ICD or ICD-9 codes relating to a performed surgical procedure), respectively. The medical-intervention dimension can include data tables that are configured to store information regarding medical-intervention treatment programs. The drug dimension can include data tables configured to store information about drugs used by a member, such as a drug name, a therapeutic category, national drug classification (NDC) information, equivalent drugs, brand or generic information, or other desired information. The medical-treatment entity 506 allows for analysis of costs of various aspects of treatment, as well as the effectiveness (or ineffectiveness) of intervention programs.

The prescription entity 508 is shown relating to numerous other entities, including the health plan entity 502 and the member entity 504 described above, the time entity 518, and a formulary entity 520.

The prescription entity 506 can include information about prescriptions, such as drugs and the like. For example, the prescription entity 506 can include a drug dimension. The drug dimension can include data tables configured to store information about drugs used by a member, such as a drug name, a therapeutic category, national drug classification (NDC) information, equivalent drugs, brand or generic information, or other desired information.

The employment entity 510 is related to the member entity 504, and can be optionally related to a health-plan entity 502 either directly or indirectly, although such an optional relationship is not shown. The employment entity 510 can include employment information related to an individual (e.g., a benefit plan member or beneficiary) associated with a benefit plan.

For example, the employment entity 510 can include an employment-status dimension and an employer dimension. The employment-status dimension can, for example, include data tables configured to store information regarding whether or not an employee (e.g., a member) is a full-time or part-time employee, or if an employee has been laid-off. This information may be important, for example, in determining premium and co-payment amounts, which may be significantly different for a member who has been laid-off (e.g., a member who is now covered by a Consolidated Omnibus Budget Reconciliation Act, or COBRA, plan, etc.). The employer dimension can contain information specific to the employer (e.g., a plan administrator or sponsor), and can contain information relating the employer to an employee (e.g., a member), such as data tables containing the employee's primary and secondary business units within the employer's company. This information can be used, for example, to determine the types of benefits available to the member, if benefits vary by business unit or type of employment, for example.

The carve-out entity 512 is shown relating to other entities, including the member entity 504 and the medical-treatment entity 506 described above. The carve-out entity 512 includes information about third-party coverage for specifically carved-out services. Carved-out services can include, for example, maternity/newborn care, mental health/substance abuse care, and physical therapy. These services can be modeled individually, or together with a main benefit plan.

The service-location entity 514 is shown relating to the medical-treatment entity 506 described above. The serviced-location entity 514 can include a geography dimension, which includes data tables that identify a geographic location of a member (e.g., city, state, and zip code information, etc.). Additionally or alternatively, the service-location entity 514 can include a service-location dimension that includes similar geographic information specific to a service location where treatment is received by a member, and which could include, for example, Medicare or Medicaid participant information, or other important information associated with a service location.

The Medicare entity 516 is shown relating to the medical-treatment entity 506, described above. The Medicare entity 516 includes information about Medicare related treatment, events, and/or expenses. For example, the Medicare entity 516 can include a coverage dimension, a claim dimension, a provider dimension, a beneficiary dimension, and other information. The coverage dimension and claim dimension can include, for example, one or more data tables storing coverage-type information and claim information, respectively. A provider dimension can include information about a provider used under a health care plan, such as specialty information and provider-type information. This information can be used, for example, to analyze the validity of diagnosis codes received from a provider, or to analyze costs for different types of providers (e.g., doctor versus dentist, specialist versus generalist, “in-plan” versus “out-of-plan,” etc.). The beneficiary dimension can include specific information about beneficiaries. For example, the beneficiary dimension can include information about groups associated with an individual, such as adjusted clinical groups (ACGs), member condition groups (MCGs), and other groups. Additionally, the beneficiary dimension can include additional information about beneficiaries, such as salary level information, disability information, gender information, or other information desired or required according to one or more embodiments of the invention.

The time entity 518 is shown relating to the medical-treatment entity 506 and the prescription entity 508, described above. The time entity 518 includes ail time information in a time dimension. Information within the time dimension can be stored in a number of data tables configured to store and relate information regarding time periods, such as day, month, quarter, year, fiscal month, fiscal quarter, fiscal year, month of the year, and predetermined time periods (e.g., a rolling 12-month period, a rolling 4-quarter period, etc.). Using the predetermined time periods, a healthcare plan administrator can analyze all costs, claims, and/or data within a previous predetermined window of time (e.g., the previous 12 months, the previous 4 quarters, etc.).

The formulary entity 520 is shown relating to the prescription entity 508, described above. The formulary entity 520 includes information about a prescription benefit plan's formulary structure. This structure determines the level of benefits for different tiers of drugs. For example, less coverage can optionally be offered for certain brand-name drugs that also have a generic alternative available.

From the foregoing, it can be seen that one or more systems and methods for modeling benefits are discussed. Specific examples of a medical benefits model, a prescription benefits model, and a retirement benefits model have been described above. It will be appreciated, however, that embodiments of the invention can be in other specific forms without departing from the spirit or essential characteristics thereof. For example, the system and method of the invention can be used with any benefit plan that can be modeled according to the principles described herein.

It will be recognized that many components and/or steps of the invention can be implemented interchangeably in software or hardware, or using a suitable combination of both. Additionally, the order of operations or steps of a process can be interchanged within the context of the invention. The presently disclosed embodiments are, therefore, considered in all respects to be illustrative and not restrictive.

What is claimed is:

1. A processor-readable medium comprising code representing instructions to cause a processor to:
analyze data of at least one individual from a plurality of individuals associated with a benefit plan, the data including information about benefits provided to the at least one individual under the benefit plan; and
model at least one expense from a plurality of expenses of the benefit plan at least partially based on the analyzed data, the code representing instructions to cause a processor to model being configured to determine a change in at least one expense from the plurality of expenses based on a modification of a parameter of the benefit plan.

2. The processor-readable medium of claim 1, wherein the change in the at least one expense is determined substantially in real-time.

3. The processor-readable medium of claim 1, wherein the benefit plan includes at least one of: a medical benefit plan, a pharmacy benefit plan, and a retirement benefit plan.

4. The processor-readable medium of claim 1, wherein the analyzed data includes a member condition group (MCG) associated with the at least one individual.

5. The processor-readable medium of claim 1, wherein the analyzed data includes information about an expenditure under the benefit plan for the at least one individual.

6. The processor-readable medium of claim 1, wherein the analyzed data includes enrollment information associated with at least one individual.

7. The processor-readable medium of claim 1, wherein the analyzed data includes information about an expenditure under the benefit plan for the at least one individual, the expenditure including at least one of: a co-payment amount, a co-insurance amount, a deductible, an out-of-pocket maximum, a cost of medical treatment, a cost of a prescription, and a cost of a retirement-related event.

8. The processor-readable medium of claim 1, wherein the analyzed data includes information about an expenditure under the benefit plan for the at least one individual, the expenditure including at least one of: an amount paid by an administrator of the benefit plan, an amount paid by an employer of an individual from the plurality of individuals, an amount paid by an individual from the plurality of individuals, and an amount paid under a government plan.

9. The processor-readable medium of claim 1, wherein the at least one expense includes at least one of: an amount paid by an administrator of the benefit plan, an amount paid by an employer of an individual from the plurality of individuals, an amount paid by an individual from the plurality of individuals, and an amount paid under a government plan.

10. The processor-readable medium of claim 1, wherein the benefit plan is a medical benefit plan, the parameter including at least one of: a co-payment amount, a co-insurance amount, a deductible, an out-of-pocket maximum amount, a network indicator, an expected enrollment change indicator, an inflation trend indicator, and an induction factor.

11. The processor-readable medium of claim 1, wherein the benefit plan is a pharmacy benefit plan, the parameter including at least one of: a co-payment amount, a co-insurance amount, a deductible, an out-of-pocket maximum amount, a formulary indicator, a mandatory mail order requirement, an expected enrollment change indicator, an inflation trend indicator, an induction factor, and an option indicator.

12. The processor-readable medium of claim 1, wherein the benefit plan is a retirement benefit plan, the parameter including at least one of: a health care plan integration indicator, a deductible, a co-insurance amount, an out-of-pocket maximum amount, a prescription drug benefit indicator, an induction factor, an expected enrollment change indicator, and an inflation trend indicator.

13. The processor-readable medium of claim 1, wherein the benefit plan is from a plurality of benefit plans, the code representing instructions to cause a processor to model the at least one expense being configured to model at least one expense from a plurality of expenses, each benefit from the plurality of benefit plans being at least partially based on the analyzed data, the code representing instructions to cause a processor to model being configured to determine a change in at least one expense from the plurality of expenses based on a modification of a parameter of the plurality of benefit plans.

14. A system, comprising:
a data repository configured to store information associated with a plurality of individuals; and
a processor in communication with the data repository, the processor being configured to associate information associated with at least one individual from the plurality of individuals with at least one parameter of a benefit plan associated with the at least one individual, the processor being further configured to determine how a modification of the at least one parameter would change at least one expense from a plurality of expenses associated with the benefit plan for each individual from the plurality of individuals.

15. The system of claim 14, wherein the processor is configured to associate the information associated with the at least one individual from the plurality of individuals with the at least one parameter of the benefit plan associated with the at least one individual based on a data model of the data repository.

16. The system of claim 14, wherein the data repository is one of a plurality of data repositories.

17. The system of claim 14, wherein the data repository includes multiple data repositories, having at least one of: a prescription data repository, a medical data repository, and a retirement data repository.

18. The system of claim 14, wherein the data repository includes multiple data repositories, having at least one of: a vision data repository, a dental data repository, a disability data repository, a workers compensation data repository, and a general ledger data repository.

19. The system of claim 14, further comprising:
an interface component in communication with the processor, the interface component being configured to cause the processor to execute instructions.

20. The system of claim 14, further comprising:
an interface component in communication with the processor via a network, the interface component being configured to cause the processor to execute instructions.

21. The system of claim 14, further comprising:
an interface component in communication with the processor, the interface component including an application server configured to cause the processor to execute instructions according to at least one predetermined rule.

22. The system of claim 14, further comprising:
an interface component in communication with the processor, the interface component being configured to cause the processor to execute instructions according to communications received via a network from a remote entity.

23. The system of claim 14, further comprising:
a remote interface component configured to receive input from a user and to send instructions based on the received input; and
an interface component in communication with the processor and the remote interface component, the interface component being configured to cause the processor to locally execute instructions received from the remote interface via a network.

24. A processor-readable medium comprising code representing instructions to cause a processor to:
receive a query associated with at least one parameter of a benefit plan, the query configured to request information about a change of expenses associated with the benefit plan based on a modification of the at least one parameter; and
determine in substantially real-time the information requested by the query using information associated with a plurality of individuals associated with the benefit plan.

25. The processor-readable medium of claim 24, further comprising code representing instructions to cause a processor to:
output the information requested by the query.

26. The processor-readable medium of claim 24, wherein the code representing instructions to cause a processor to determine is configured to request data associated with the query from a data repository, the code representing instructions to cause a processor to determine being further configured to apply at least one predetermined rule to data received from the data repository.

27. The processor-readable medium of claim 24, wherein the code representing instructions to cause a processor to determine is configured to request data associated with the query from a data repository using a request formatted using a database query language, the code representing instructions to cause a processor to determine being further configured to apply at least one predetermined rule to data received from the data repository using an instruction encoded using a lower-level programming language.

28. The processor-readable medium of claim 24, wherein the query is received from a remote device via a network.

29. The processor-readable medium of claim 24, wherein the query is formed at least partially based on input from a user.

30. The processor-readable medium of claim 24, wherein the code representing instructions to cause a processor to determine is configured to request the information about a change of expenses associated with the benefit plan at least partially based on information associated with the benefit plan.

31. The processor-readable medium of claim 24, wherein the requested information is stored in a data model including information associated with the benefit plan, the benefit plan including at least one of: a medical benefit plan, a prescription benefit plan, a retirement benefit plan.
